(19) United States
(12) Patent Application Publication
(10) Pub. No.: US 2003/0189923 A1
(43) Pub. Date: Oct. 9, 2003

(54) Data switching process

(76) Inventor: Ronald J. Gagnon, Ottawa (CA)

Correspondence Address: FISH & RICHARDSON PC, 225 FRANKLIN ST, BOSTON, MA, 02110, US

(21) Appl. No.: 10/117,694

(22) Filed: Apr. 5, 2002

(51) Int. Cl. H04L 12/50; H04Q 11/00

(52) U.S. Cl. 370/360

(57) ABSTRACT

A switch core includes a first switch element which receives a trigger and changes a first connection map at a predetermined point relative to receipt of a data frame following the trigger and a second switch element which receives the trigger and changes a second connection map at a predetermined point relative to receipt of a data frame following the trigger.

### TECHNICAL FIELD

This application relates generally to switching data and, more particularly, to a data switching process that aspires to provide substantially hitless switching.

### BACKGROUND

Large switch cores are typically built up of smaller interconnected switch elements and may contain multiple switching stages. Data is passed through a switch core serially, from one switch stage to the next. Each switch stage may include multiple switch elements. In operation, a switch element in a first switch stage receives blocks of data (also referred to as frames) for each connection. That switch element routes segments of data from different connections to different switch elements on the next switch stage. The destination of each data segment is defined in a connection map stored for each switch stage.

It is sometimes necessary to change the path that a connection takes through a switch core while still maintaining the same destination (e.g., in order to upgrade or change some elements of the switch core or to relieve blocking). In order to do this, the connection map(s) of one or more switch elements may be changed. Heretofore, changing the connection map could result in substantial data loss or corruption, particularly if the connection map changes are not synchronized across the various switch elements and occur at different points in the data frames. This data loss is called a “traffic hit”.

“Hitless” switching refers to data switching in which data is not lost during routing changes in the switch core.

### SUMMARY

In general, in one aspect, the invention is directed to transmitting data through a switch core that includes a switch element. This aspect includes receiving a trigger, recognizing the trigger, changing a connection map at a predetermined point relative to receipt of a data frame following recognizing the trigger, and transmitting subsequent data through the switch element in accordance with the changed connection map. This aspect of the invention may also include one or more of the following features.

The trigger may be a data word. Recognizing the trigger may include comparing two consecutive data words to register values. Connection maps may be pre-loaded for the switch element. Changing the connection map may include selecting one of the plural connection maps for use by the switch element. The switch core may include plural switch elements. The trigger may be included in a system clock signal. The predetermined point may be a start of the data frame.

In general, in another aspect, the invention is directed to a switch core that includes a first switch element which receives a trigger and changes a first connection map at a predetermined point relative to receipt of a data frame following the trigger, and a second switch element which receives the trigger and changes a second connection map at a predetermined point relative to receipt of a data frame following the trigger. This aspect of the invention may include one or more of the following features.

The switch core may include a third switch element which receives the trigger and changes a third connection map at a predetermined point relative to receipt of a data frame following the trigger. The first switch element may recognize the trigger, change the first connection map following recognizing the trigger, and transmit subsequent data to the second switch in accordance with the changed first connection map. The second switch element may recognize the trigger, change the first connection map following recognizing the trigger, and transmit subsequent data to a third switch in accordance with the changed second connection map.

The first switch element and the second switch element may receive a trigger to initiate connection map change. The trigger may be encoded in a system clock signal. The trigger may be a data word. The first switch element may receive data and output segments of the data to different destinations. The second switch element may receive at least one of the segments from the first switch element.

Other features and advantages of the invention will become apparent from the following description and drawings.

### DESCRIPTION OF THE DRAWINGS

FIG. 1 is a block diagram of a switching device.

FIG. 2 is a block diagram of a portion of a switch core in the switching device.

FIG. 3 is a flowchart showing a process for changing a routing configuration for a switch element in the switch core.

Like reference numerals in different figures indicate like elements.

### DESCRIPTION

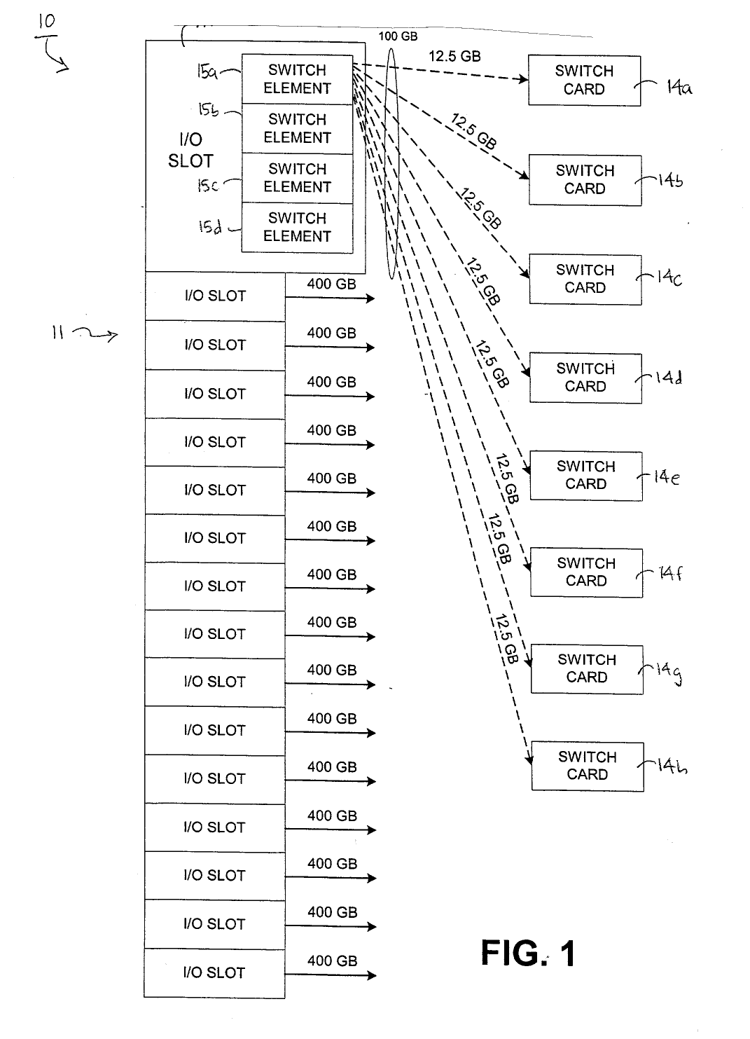

Referring to FIG. 1, a portion 10 of a switching device is shown. The switching device contains sixteen (16) input/output (I/O) slots 11. The data to be switched is arranged in blocks of data, also called frames. In this embodiment, each connection supports 8000 frames-per-second at a data rate of approximately 51.84 Mb/s. A switching element managing 100 Gb/s actually manages 1920 separate connections.

Each I/O slot 12 outputs four hundred (400) gigabits per second (Gb/s) of data to various switch cards 14a to 14h. To this end, each I/O slot contains four switch elements 15a to 15d. Each switch element outputs one hundred (100) Gb/s of data to the switch cards. The 100 Gb/s is segmented into 12.5 Gb/s portions, each of which is routed to one of the eight switch cards, as shown. Each switch card thus receives 12.5 Gb/s of data from each of four switch elements in each of sixteen I/O slots, resulting in a total of eight hundred (800) Gb/s received per switch card (i.e., 12.5*16*4=800).

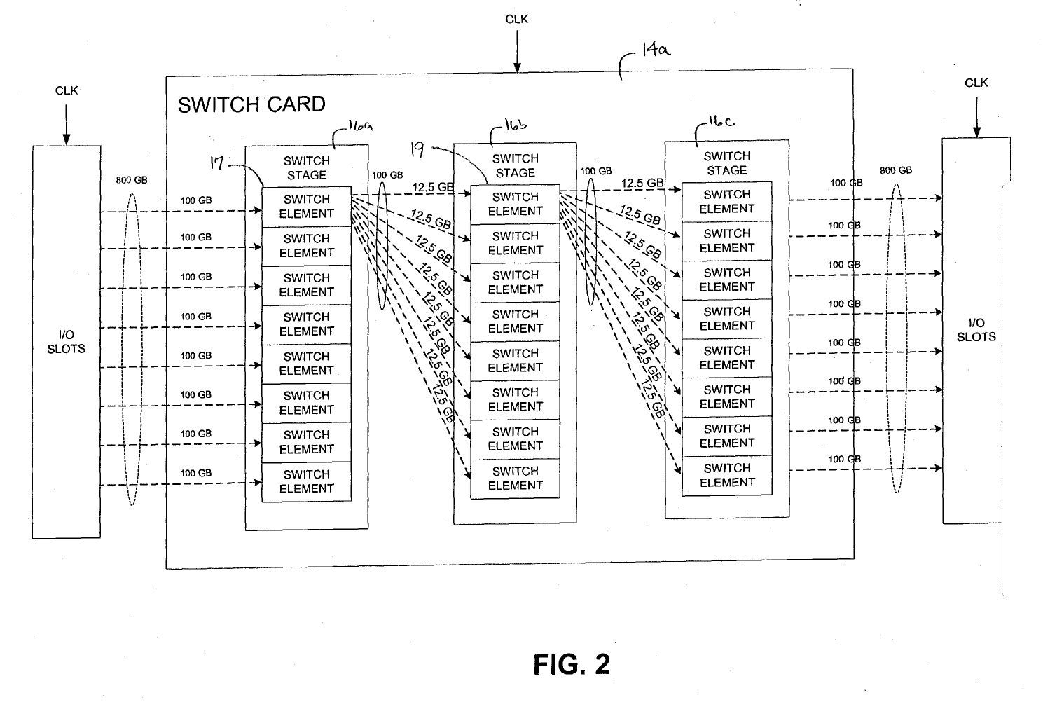

I/O slots 11 are bi-directional in the sense that they transmit data to a switch card and receive data from the switch card. In this embodiment, each of I/O slots 11 is capable of outputting 50 Gb/s of data to a single switch card and of receiving 50 Gb/s of data from that same switch card. For the sake of illustration, in FIG. 2 below the input portion of I/O slots 11 is shown at the input of switch card 14a and the output portion of I/O slots 11 is shown at the output of switch card 14a. It should be noted, however, that the input and output portions of the I/O slots are actually at the same physical location.

The eight switch cards 14a to 14h make up a switch core. FIG. 2 shows one of the switch cards 14a in detail. In this example, switch card 14a includes three switch stages 16a to 16c arranged in series. These switch stages will be referred to as first switch stage 16a, second switch stage 16b, and third switch stage 16c. Each of the switch stages is comprised of eight switch elements in this embodiment. In operation, a switch element receives 100 Gb/s, segments the bandwidth, and outputs eight 12.5 Gb/s segments to eight different destinations. The operation of the switch elements in the switch core is the same as the operation of the switch elements in the I/O slots, resulting, essentially, in five-stage switching.

By way of example, switch element 17 in first switch stage 16a receives 100 Gb/s of data and outputs 12.5 Gb/s to each of the switch elements in second switch stage 16b. The remainder of the switch elements in first switch stage 16a operate in the same manner. In second switch stage 16b, a switch element 19 receives 100 Gb/s (12.5 Gb/s from each of the switch elements on first switch 16a). Switch element 19 transmits 12.5 Gb/s to each switch element on third switch stage 16c. The remaining switch elements operate similarly. The switch elements on third switch stage 16c operate in the same manner as those on the first and second switch stages.

As noted above, FIG. 2 represents only a single switch card in the switch core. In this embodiment, the remainder of the switch core includes seven additional switch cards (see FIG. 1). The eight switch cards operate in parallel. That is, a given connection takes a path through only one of the eight switch cards. Data is not transmitted between the switch cards. Only one switch card is used to describe the process claimed herein; accordingly, only one card is shown in FIG. 2.

Each switch element, in both the switch cards and the I/O slots, has an associated connection map. This connection map may be stored in a memory on a chip (e.g., application-specific integrated circuit (ASIC)) on which the switch card or I/O slots is formed. The connection map contains routing information for each switch element. This routing information maps the source of a block of data to one or more destinations on a next switch element. Each switch element (in a switch card and I/O slot) has two or more associated connection maps. Only one connection map is used (termed active map) and the others are inactive. A map change involves changing which map is active. The connection maps may define different data routing schemes for the switch elements. To change data routing, the connection maps may be changed. A process 20, which changes the connection maps and performs substantially hitless switching, is described below. In this embodiment, a system clock signal (CLK) comprised of a 38.88 MHz frequency reference and an 8 Kilohertz (KHz) reference signal is broadcast to all switching elements. An 8-bit data word that serves as a trigger is encoded on the same physical lines as the system clock signal. The 8 KHz clock indicates the data frame boundary. The 8-bit data word appears in the middle of the 8 KHz clock cycle. Each switch element can offset its local 8 KHz timing, which corresponds to received data frames at that switch element, from the 8 KHz reference to account for propagation delays through the various switching stages. Connection map switches occur at a pre-determined point relative to the received data frames.

In this embodiment, the trigger is a sequence of two values in two consecutive 8 Khz cycles. For example, the trigger could be defined as 10101010 followed by 01010101. Any type of trigger may be used; thus, the invention is not limited to using a data sequence as its trigger. The trigger is used to initiate a change of connection maps for one or more switching elements. This is described in process 20 below. It is noted that the trigger is not sent continuously (e.g., at periodic intervals), but rather the trigger is only sent to change switch element connection maps.

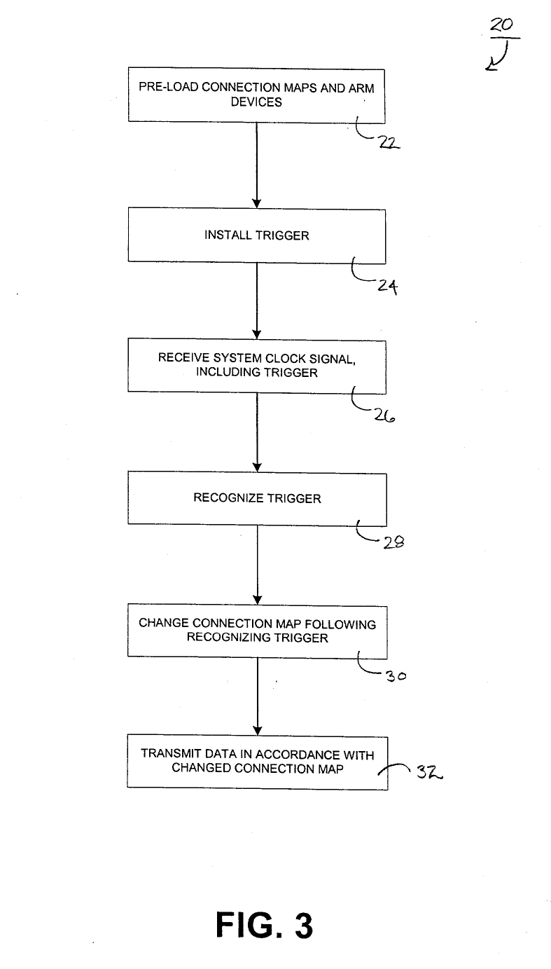

Referring to FIG. 3, process 20 may be performed by each switch element on its own (e.g., in hardware), by a processor that controls the switch core (e.g., in software), or a combination of the two (e.g., hardware and software combined). Process 20 pre-loads (i.e., stores) (22) the new connection maps (e.g., two or more) for each affected switch element. In this application, the switch elements in the I/O slots are treated the same as those in the switch cards. Process 20 arms the switch elements, meaning that it signals the switch elements on the switch cards and I/O slots thereby allowing them to recognize the trigger and respond accordingly.

Process 20 installs (24) the trigger (e.g., the data sequence) in the system clock signal and the trigger is received (26) by the each switching element. Process 20 recognizes (28) the trigger.

In more detail, taking the switch elements in second switch stage 16b as an example, process 20 recognizes (28) the data sequence in the system clock signal. In this embodiment, process 20 recognizes the data sequence by comparing two consecutive data values (e.g., a current 8 Khz cycle and a last 8 Khz cycle) and comparing them to values provisioned (i.e., stored) in registers in the switch element. If the two values match, process 20 triggers a change in connection maps for one or more of the switch elements.

The trigger is received roughly in correspondence with receipt of the middle of a data frame. In this way, it is ensured that each switch element will receive the trigger in time (relative to the data frame) to switch the connection map at the start of a next data frame without losing substantial amounts of data. The trigger arrives at all the switch elements before the end of a given frame so that all switch elements switch connection maps on the same data frame boundary. Since the frame duration is 125 psec (microseconds), the trigger is sent at approximately at 62.5 usec, and a delay variation in the broadcast of the trigger, of tens of nsec (nanoseconds) is easy to achieve, implementation is relatively straightforward. Process 32 changes (30) the connection maps at the start of a next data frame and transmits (32) data through the switch using the new connection map. Thus, for example, switch elements 17 and 19 receive the trigger at roughly the same time before a next data frame (e.g., in the middle of a current data frame) and change their connection maps at the start of a next data frame.

Process 20 may pre-program which connection map is to be substituted for a current switch element connection map or information selecting a connection map may be input from an external source. In any case, a change in connection maps is not triggered until the switch element recognizes the trigger. As noted, the connection maps for each switch element will be changed at the same time relative to the start of a data frame. This may occur, however, at different absolute times because of propagation delay through the switching stages. The frame boundary used for switching will move ahead in time as we propagate through the various switch stages. For example, the connection maps for switch elements in the first switch stage 16a may be changed first in time; the connection maps for switch elements in the second switch stage 16b may be changed next in time; and the connection maps for switch elements in the third switch stage 16c may be changed last in time (although the connection maps are all changed at the same time relative to the start of a next data frame arriving at the switch element). Changing connection maps at the same time relative to received data results in less data loss incurred during changing, thereby coming closer to substantially hitless switching.

Process 20 is not limited to use with the hardware and software described above; it may find applicability in any computing or processing environment. Process 20 may be implemented in hardware, software, or a combination of the two. For example, process 20 may be implemented using circuitry, such as one or more of programmable logic (e.g., an ASIC), logic gates, a processor, and a memory.

Process 20 may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform process 20. Process 20 may also be implemented as a machine-readable storage medium, configured with a computer program, where, upon execution, instructions in the computer program cause a machine to operate in accordance with process 20.

Embodiments of process 20 may be used in a variety of applications. Although process 20 is not limited in this respect, process 20 may be used with memory devices in microcontrollers, general purpose microprocessors, digital signal processors (DSPs), reduced instruction-set computing (RISC), and complex instruction-set computing (CISC), among other electronic components. However, it should be understood that process 20 is not limited to use with these examples.

Embodiments of process 20 may also be included in integrated circuit blocks referred to as core memory, cache memory, or other types of memory that store electronic instructions to be executed by a microprocessor or store data that may be used in arithmetic operations.

The invention is not limited to the embodiments described above. For example, the blocks of FIG. 3 may be rearranged and/or executed out of order to produce the results described above. Process 20 may be used with switch cores having different circuit configurations than those shown in FIGS. 1 and 2. For instance, more or less than three switch stages may be included in series and more or less than eight switch elements may be included in parallel. More or less than eight switch elements may be used per switch stage. I/O slots other than those described above may be used or devices other than I/O slots may be used to provide the data to the series of switches.

Other embodiments not described herein are also within the scope of the following claims.

What is claimed is:

1. A method of transmitting data through a switch core that includes a switch element, the method comprising:
receiving a trigger;
recognizing the trigger;
changing a connection map at a predetermined point relative to receipt of a data frame following recognizing the trigger; and
transmitting subsequent data through the switch element in accordance with the changed connection map.

2. The method of claim 1, wherein the trigger comprises a data word.

3. The method of claim 1, wherein recognizing the trigger comprises comparing two consecutive data words to register values.

4. The method of claim 1, further comprising:
pre-loading plural connection maps for the switch element;
wherein changing the connection map comprises selecting one of the plural connection maps for use by the switch element.

5. The method of claim 1, wherein the switch core comprises plural switch elements.

6. The method of claim 1, wherein the trigger is included in a system clock signal.

7. The method of claim 1, wherein the predetermined point comprises a start of the data frame.

8. A switch core comprising:
a first switch element which receives a trigger and changes a first connection map at a predetermined point relative to receipt of a data frame following the trigger; and
a second switch element which receives the trigger and changes a second connection map at a predetermined point relative to receipt of a data frame following the trigger.

9. The switch core of claim 8, further comprising:
a third switch element which receives the trigger and changes a third connection map at a predetermined point relative to receipt of a data frame following the trigger.

10. The switch core of claim 8, wherein the first switch element:
recognizes the trigger;
changes the first connection map following recognizing the trigger; and
transmits subsequent data to the second switch in accordance with the changed first connection map.

11. The switch core of claim 8, wherein the second switch element:
recognizes the trigger;
changes the first connection map following recognizing the trigger; and
transmits subsequent data to a third switch in accordance with the changed second connection map.

12. The switch core of claim 8, wherein the first switch element and the second switch element receive a trigger to initiate connection map change, the trigger being encoded in a system clock signal.

13. The switch core of claim 12, wherein the trigger comprises a data word.

14. The switch core of claim 8, wherein:
the first switch element receives data and outputs segments of the data to different destinations; and
the second switch element receives at least one of the segments from the first switch element.

15. A switch to transmit data through a switch core, the switch comprising:
circuitry to (i) receive a trigger, (ii) recognize the trigger, (iii) change a connection map at a predetermined point relative to receipt of a data frame following recognizing the trigger, and (iv) transmit subsequent data through the switch in accordance with the changed connection map.

16. The switch of claim 15, wherein the trigger comprises a data word.

17. The switch of claim 15, wherein recognizing the trigger comprises comparing two consecutive data words to register values.

18. The switch of claim 15, wherein:
the circuitry pre-loads plural connection maps; and
changing the connection map comprises selecting one of the plural connection maps.

19. The switch of claim 15, wherein the trigger is received in a system clock signal.

20. The switch of claim 15, wherein the switch core comprises plural switches elements in series.

21. The switch of claim 15, wherein the circuitry comprises at least one of programmable logic, logic gates, a processor, and a memory.

22. A machine-readable medium which stores executable instructions to control transmission of data through a switch core that includes a switch element, the instructions causing the switch element to:
receive a trigger;
recognize the trigger;
change a connection map at a predetermined point relative to receipt of a data frame following recognizing the trigger; and
transmit subsequent data through the switch element in accordance with the changed connection map.

23. The machine-readable medium of claim 22, wherein the trigger comprises a data word.

24. The machine-readable medium of claim 22, wherein recognizing the trigger comprises comparing two consecutive data words to register values.

25. The machine-readable medium of claim 22, further comprising instructions that cause the switch element to:
pre-load plural connection maps for the switch element;
wherein changing the connection map comprises selecting one of the plural connection maps for use by the switch element.

26. The machine-readable medium of claim 22, wherein the predetermined point comprises a start of the data frame.

27. The machine-readable medium of claim 26, wherein the switch core comprises plural switch elements in series.

28. The switch of claim 25, wherein the predetermined point comprises a start of the data frame.
